(19) United States
(12) Patent Application Publication
(10) Pub. No.: US 2025/0013736 A1
(43) Pub. Date: Jan. 9, 2025

(54) APPARATUS, METHOD, AND COMPUTER-READABLE MEDIUM FOR A LOCAL ATTESTATION SERVICE

(71) Applicants: Rajesh POORNACHANDRAN, Portland, OR (US); Marcos E. CARRANZA, Portland, OR (US); Rita H. WOUHAYBI, Portland, OR (US); Cesar MARTINEZ-SPESSOT, Hillsboro, OR (US)

(72) Inventors: Rajesh POORNACHANDRAN, Portland, OR (US); Marcos E. CARRANZA, Portland, OR (US); Rita H. WOUHAYBI, Portland, OR (US); Cesar MARTINEZ-SPESSOT, Hillsboro, OR (US)

(21) Appl. No.: 18/896,679

(22) Filed: Sep. 25, 2024

(51) Int. Cl. G06F 21/52

(52) U.S. Cl. CPC G06F 21/52; G06F 2221/034

(57) ABSTRACT

An apparatus, method, and computer-readable medium for a local attestation service of a network within a trust cluster. The apparatus comprises memory, machine-readable instructions, and processor circuitry configured to execute the machine-readable instructions to communicate with a selected node outside the trust cluster, attest the selected node, and, when attestation of the selected node is successful, register the selected node within the trust cluster.

### BACKGROUND

Attestation services are critical for verifying the integrity and trustworthiness of computing environments, ensuring that systems are secure and operating as intended. However, centralized, single-point attestation services present scalability challenges for customers whose infrastructure and resources are distributed across diverse locations. In edge computing scenarios, where computational resources are often limited, there are situations in which it is not possible to cover the cover compute requirements or implement the necessary features needed to secure a system with a centralized attestation service. Furthermore, customers operating entirely on-premises, such as certain healthcare providers or research institutions, might avoid using centralized or public cloud services solely for Attestation-As-A-Service (AaaS) due to concerns over data privacy, regulatory compliance, and dependency on external infrastructure. Therefore, an improved apparatus, method, and computer-readable medium for a local attestation service may be desired.

### BRIEF DESCRIPTION OF THE FIGURES

Some examples of apparatuses and/or methods will be described in the following by way of example only and with reference to the accompanying figures, in which:

FIG. 1 shows a block diagram of an example of an apparatus for a local attestation service of a network within a trust cluster;

FIG. 2 shows an example system employing tiered AaaS;

FIG. 3 shows an example system with attestation boundaries and the addition of a new node;

FIG. 4 shows a flowchart of a method for a local attestation service; and

FIG. 5 illustrates a computing device for a local attestation service.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

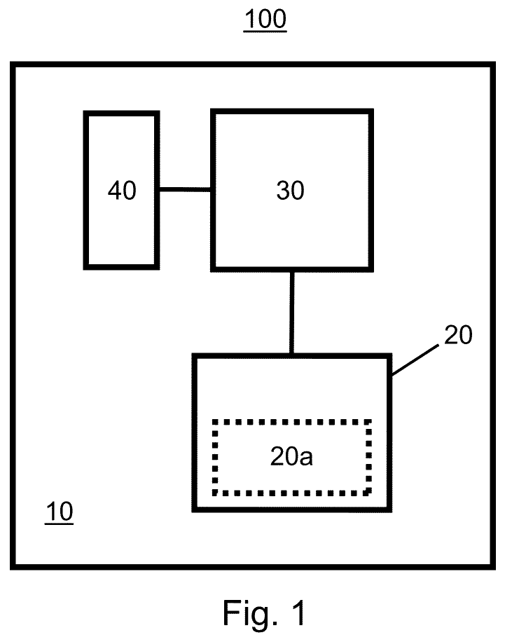

FIG. 1 shows a block diagram 100 of an example of an apparatus 10 (or device 10) for a local attestation service of a network within a trust cluster. The apparatus 10 may comprise memory circuitry 20, machine-readable instructions 20a, and processor circuitry 30 to execute the machine-readable instructions. The apparatus 10 may be part of a system 100. For example, the processing circuitry 30 may be configured to provide the functionality of the apparatus 10, in conjunction with the interface circuitry 40. For example, the interface circuitry 40 is configured to exchange information, e.g., with other components inside or out-side the apparatus 10 and the storage circuitry 20. Likewise, the device 10 may comprise means configured to provide the functionality of the device 10.

The components of the device 10 are defined as component means, which may correspond to, or be implemented by, the respective structural components of the apparatus 10. For example, the device 10 of FIG. 1 comprises means for processing 30, which may correspond to or be implemented by the processing circuitry 30, means for communicating 40, which may correspond to or be implemented by the interface circuitry 40, and (optional) means for storing information 20, which may correspond to or be implemented by the storage circuitry 20. In the following, the functionality of the device 10 is illustrated with respect to the apparatus 10. Features described in connection with the apparatus 100 may thus likewise be applied to the corresponding device 10.

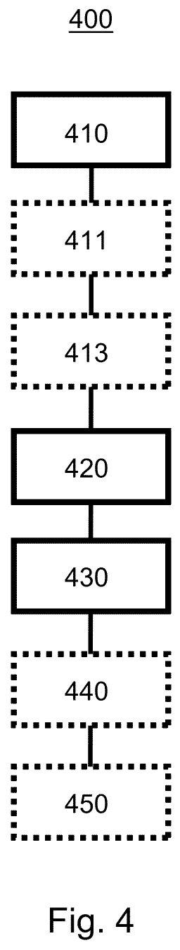

In general, the functionality of the processing circuitry 30 or means for processing 30 may be implemented by the processing circuitry 30 or means for processing 30 executing machine-readable instructions 20a. Accordingly, any feature ascribed to the processing circuitry 30 or means for processing 30 may be defined by one or more instructions of a plurality of machine-readable instructions 20a. The apparatus 10 or device 10 may comprise the machine-readable instructions, e.g., within the storage circuitry 20 or means for storing information 20. For example, the processor circuitry 30 or means for processing 30 may perform a method shown in the present disclosure, such as the method discussed in connection with FIG. 4.

The interface circuitry 40 or means for communicating 40 may correspond to one or more inputs and/or outputs for receiving and/or transmitting information, which may be in digital (bit) values according to a specified code, within a module, between modules or between modules of different entities. For example, the interface circuitry 40 or means for communicating 40 may comprise circuitry configured to receive and/or transmit information.

For example, the processing circuitry 30 or means for processing 30 may be implemented using one or more processing units, one or more processing devices, or any means for processing, such as a processor, a computer, or a programmable hardware component being operable with accordingly adapted software. In other words, the described function of the processing circuitry 30 or means for processing 30 may as well be implemented in software, which is then executed on one or more programmable hardware components. Such hardware components may comprise a general-purpose processor, a Digital Signal Processor (DSP), a micro-controller, etc.

For example, the storage circuitry 20 or means for storing information 20 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The apparatus 10 may be configured to communicate with a selected node outside the trust cluster, attest the selected node, and register the selected node within the trust cluster when attestation of the selected node is successful. The apparatus may be the local trust authority or an Attestation as a Service (AaaS) system responsible for managing trust and attestation within the network.

Centralized attestation services might not be scalable for customers that have their infrastructure and resources in various locations involving on-premises private enterprise edge, remote public cloud, on-premises version of a public cloud stack, and other various combinations. In edge computing, computational processes and data storage are strategically positioned in proximity to the data generation sources, thereby minimizing the latency and bandwidth consumption typically associated with centralized cloud-based systems. This architectural framework encompasses a network of distributed nodes, which may include but are not limited to IoT devices, sensors, gateways, and local servers, each endowed with processing capabilities to execute data analysis, real-time decision-making, and application-specific tasks at or near the point of data origination. Therefore, at the edge, resources may be limited, so there are situations in which it is impossible to cover the compute requirements (or features) needed to secure a system. Complete (e.g. 100%) on-premises stack customers, such as certain hospital systems or research institutions, might not want to connect with a centralized or public cloud solely for attestation services (AaaS).

The disclosed local trust authority may be a platform that scales to meet the demands of modern enterprise computing environments. The primary function of this local trust authority is to attest the integrity of Trusted Execution Environments (TEEs) by validating that workloads running within these environments have not been compromised. Doing so may facilitate confidential computing in multi-party scenarios. Confidential computing enables the processing of sensitive data within Confidential Computing Environments (CCEs), ensuring that data remains secure during computation. This may be true even when data is shared among multiple parties. During the COVID-19 pandemic, AaaS enabled joint collaborations between organizations like drug developers and healthcare providers to securely share and process sensitive intellectual property and health data without exposing the underlying information to potential breaches.

Attestation by a local trust authority may be accomplished through TEE-instance setup, a verification process, attestation policy matching, attestation token generation, and token verification. Users or their infrastructure providers may configure a confidential computing environment, such as a TEE, which may include workloads at the application level or virtual machine (VM) level. The TEE generates cryptographically signed evidence, which includes identity and integrity measurements of the environment. This evidence is transmitted to the local trust authority for attestation. The trust authority matches the cryptographically signed evidence against pre-defined security policies configured by the user. These policies define the expected identity and integrity metrics of the computing environment. Then, if the environment passes the attestation checks, the trust authority issues an attestation token. This token is cryptographically signed and serves as proof that the environment is trusted and secure. Any relying party can verify the attestation token's signature and ensure the environment meets the necessary security policies. Once verified, workloads and data can be safely decrypted and executed within the TEE.

The apparatus 10 for a local trust authority may be implemented by a plurality of small attestation infrastructures, that when they are detected, they may collaborate to form a more powerful cluster. Local attestation may be an ideal situation for edge computing, in which resources are limited. The attestation service may be implemented as a hierarchy of functionality, and/or communities. Ad-hoc, local, or peer-to-peer trust authority infrastructures may consider how they are formed, how they communicate with each other, and what occurs when one of them goes down or is corrupted. All of these considerations may lead to differing security gradients and handling of confidential computing tasks. Monitoring of the local trust authorities from centralized attestation services or from peers on the edge may be done in certain scenarios as a compliment or oversight to the local attestation.

Edge solutions provide the capability to extend cloud infrastructure to the edge of the network, bringing computational resources closer to data generation sources. Customers, including those with on-premises private enterprise edge setups or remote public cloud infrastructures, may utilize edge outposts to enhance operational efficiency. For instance, healthcare providers who manage HIPAA-regulated data might integrate edge computing solutions to maintain data privacy and compliance without relying on centralized public clouds, addressing their discomfort with public cloud exposure.

Bringing a trust authority to an edge network enables a variety of secure computing use cases. Competitors in highly regulated industries, such as financial services or healthcare, can securely share data or workloads, knowing that the computing environment is verified and has not been tampered with. Meanwhile, enterprises can confidently deploy sensitive workloads across multi-cloud and edge environments, ensuring that all environments meet the same prominent level of security. For example, in the oil and gas industry, attestation for wellhead controllers in oil extraction may be key for remote locations where connection with centralized attestation services is not cheap or possible.

Local trust authorities may be designed to scale seamlessly across a wide range of deployment models, from on-premises setups to hybrid cloud environments. Enterprises can maintain consistent security policies across different cloud providers without needing to invest in complex and expensive custom attestation services. Additionally, the design of the local trust authority may make it easy to deploy, configure, and manage. Enterprises may dynamically configure security policies and maintain consistency across their entire infrastructure with minimal effort. Furthermore, by implementing zero trust principles, the local trust authority helps enterprises safeguard sensitive data and workloads by ensuring that every computing environment is verified before it is trusted. For example, a financial institution could deploy sensitive workloads across multiple cloud environments, with each edge node being independently attested and integrated into the overall trust cluster.

A CCE may refer to a secure area within a computing system that isolates sensitive data and computations from other processes, including the operating system and hypervisors. This is typically achieved through hardware-based security features such as TEEs. A TEE may be provided within or by the processing circuitry, creating isolated and secure areas for executing sensitive computations and storing confidential data. A TEE may be hosted within a CCE, such that confidential computing of a workload may be carried out.

Confidential computing may refer to computing (i.e. processing of data) that is carried out in such a secure environment since a CCE may provide hardware-based security features, both within the processing circuitry and across the broader computing system comprising the processing circuitry, to protect data in use from unauthorized access and tampering.

For example, memory encryption may be used to ensure that the contents of the system memory (e.g. RAM) are encrypted to protect data even if physical access to the memory is obtained. Further, features such as I/O isolation may be used to secure input/output operations and prevent data leakage during transit between the processing circuitry and peripheral devices.

Together, these processing circuitry and system-level features may provide a robust foundation for one or more TEEs, ensuring that sensitive information and computations (or, more generally, workloads) are protected throughout their lifecycle. The TEEs operating on the system software rely on the underlying system software for its initialization, execution, and management. The system software provides the necessary services and interfaces for the TEE to function securely and efficiently.

A CCE may include one or more hierarchical layered environments. Each of the one or more layered environments may be specifically designed to perform distinct computing functions within the CCE. These layers are hierarchically structured such that a lower layer may support and attest to the integrity of a layer above it, ensuring a continuous chain of trust throughout the CCE. For example, a lower layered environment may receive a measurement from the environment layered above and sign it with its private key. One or more layered environments may be categorized into layers based on their functions within the CCE. The layers may be logically and/or hardware-separated based on their specific functions, roles, and responsibilities within the CCE, ensuring a structured and secure computing framework. For example, one or more layers may be designed to perform foundational security functions, such as a root of trust (RoT). The foundational security provides the essential security mechanisms and trust anchors upon which the entire framework is built. For example, the foundational security framework may comprise layers responsible for secure boot, cryptographic key management, and integrity verification.

Attestation may refer to a mechanism that reports on protection and integrity properties of the workload-hosting TEE and also on target environments (TE), such as the ROT and layers in between (e.g. firmware layer, integrity register layer, and the like). Attestation reports may be collected at importing events in the lifetime of the workload, such as whenever an image is updated, when the workload is migrated, or the like.

In some examples, the selected node is discovered when it is visible to a node within the trust cluster. Here, a selected node may refer to any device or system component intended to be integrated into the trust cluster, such as IoT devices, sensors, or edge servers. Discovered may imply that another trusted node (e.g. in the trust cluster) identifies and recognizes the node through mechanisms such as network scanning, broadcasting, or peer discovery protocols. The trust cluster may denote a group of nodes that have been authenticated and are trusted to communicate and share resources securely. For instance, a new IoT sensor becomes a selected node when it becomes detectable by an existing trusted gateway within the cluster, enabling seamless integration and secure communication.

In some examples, the apparatus 10 establishes a secure channel between the apparatus and the selected node. A secure channel may be a communication pathway that ensures data transmitted between the apparatus and the selected node is encrypted and protected against unauthorized access or tampering. This may involve protocols such as TLS (Transport Layer Security) or IPsec to provide confidentiality and integrity. For example, when a new edge device joins the network, the apparatus may initiate a TLS-encrypted connection to securely exchange authentication credentials and attestation data with the selected node, ensuring that all subsequent communications are safeguarded against potential threats.

In some examples, the selected node may comprise a CCE, and attesting the selected node comprises attesting the confidential computing environment. Attesting the CCE may involve verifying that the CCE is operating correctly and securely, ensuring that its data and workloads are protected from unauthorized access or manipulation. For instance, a hospital's data processing unit may operate within a CCE to safeguard patient information, and the apparatus may perform attestation to confirm the integrity and security of this environment before allowing data processing.

Attesting the CCE of the selected node may be done via an Enhanced Privacy ID (EPID) or a Gossip group protocol, for example. EPID is a cryptographic protocol that provides identity verification while preserving user privacy by allowing devices to prove their identity without revealing their exact identity to third parties. The Gossip group protocol is a decentralized communication method where nodes share information with randomly selected peers, enabling efficient and scalable dissemination of data within the network. Utilizing EPID may ensure that the selected node's identity is authenticated securely. The Gossip group protocol may facilitate distributing and verifying attestation information across the trust cluster. For example, when a new edge device is introduced, EPID verifies its identity, and the Gossip protocol ensures that this attestation is communicated to all relevant nodes within the trust cluster, maintaining consistent security across the network.

In some examples, after successful attestation, the selected node is registered to communicate with other nodes in the trust cluster, provide security services, or discover further selected nodes outside the trust cluster. Registering to communicate may enable the node to exchange data and messages securely with other trusted nodes within the cluster. Providing security services may involve the node offering functionalities such as encryption, authentication, or intrusion detection to enhance the overall security posture of the network. Discovering further selected nodes may entail identifying and integrating additional devices or systems that wish to join the trust cluster. For example, once a new edge device passes attestation, it can securely communicate with existing IoT devices, offer encryption services for data transmission, and detect and incorporate new devices that become available, thereby expanding the trust cluster's capabilities and coverage.

In some examples, prior to successful attestation, the selected node is in an evaluation phase. The evaluation or onboarding phase may refer to a preliminary period during which the node undergoes assessments to determine its compliance with the security and operational requirements of the trust cluster. This phase may include testing the node's hardware integrity, software configurations, and performance metrics to ensure it meets predefined standards. For example, a new edge device may enter the evaluation phase where its firmware is verified, its processing capabilities are tested, and its network performance is measured before it is granted full access and trust within the cluster.

The evaluation or onboarding process allows new nodes to join the trust cluster by undergoing a series of verification steps managed by local trust authorities. This might involve polling mechanisms, trust entities monitoring the health and status of clients, and dynamic provisioning based on resource availability and attestation scores. For example, when a new edge device is deployed in a new, remote location, a trust authority may check its attestation score and resource availability before provisioning it into a better location in the trust cluster.

In some examples, data produced by the selected node during the evaluation phase is marked. Marking data may involve tagging or annotating the information generated by the node to indicate its status or origin. This may be achieved through metadata tagging, digital signatures, or watermarking techniques that help track, verify, and manage data during the evaluation process. For instance, data streams from a node undergoing evaluation may be marked with a unique identifier and a status flag to differentiate them from data produced by fully attested and registered nodes. This may ensure that any analysis or processing of the data during the evaluation phase can account for its provisional status and apply appropriate handling protocols.

In some examples, the trust cluster may comprise a plurality of networks. During the evaluation phase, the selected node may be evaluated for power and/or cost efficiencies and, after successful attestation, registered with one of the plurality of networks of the trust cluster when a threshold is met. A plurality of networks may refer to multiple interconnected networks within the trust cluster, such as local enterprise networks, public cloud networks, or hybrid cloud environments. When a node is evaluated for power or cost efficiencies, its energy consumption and operational costs may be assessed to ensure optimal resource utilization and economic viability. A threshold may be a predefined benchmark or criteria that the node must meet to qualify for registration within a specific network. For example, during evaluation, an edge device may be tested for its energy usage and processing costs, and if it operates below the established thresholds, it is registered to join the most cost-effective and energy-efficient network within the trust cluster, thereby optimizing overall resource management.

In some examples, after registering the selected node within the trust cluster, the system periodically reevaluates the selected node for power and/or cost efficiencies and migrates the selected node to another network within the trust cluster when a threshold is met. Reevaluation may involve conducting regular assessments of the node's operational performance and resource consumption over time. Migration may refer to moving the node's operational tasks, data processing, or connectivity from one network to another to maintain optimal performance and cost-effectiveness. When a node's power usage or cost metrics exceed or fall below the defined thresholds, indicating inefficiency or underutilization, the system may autonomously relocate the node to a more suitable network within the trust cluster. For instance, an edge device initially assigned to a high-performance network may be migrated to a lower-cost network if ongoing evaluations reveal that its processing demands have decreased, thereby reducing operational expenses and conserving energy resources.

In some examples, the apparatus 10 is an edge apparatus of the network. An edge apparatus may refer to a device or system component located at the periphery of the network, close to data sources and end-users, responsible for processing data locally rather than relying solely on centralized cloud servers. This proximity may enable faster data processing, reduced latency, and more efficient bandwidth usage. When the apparatus functions as an edge apparatus, it can perform critical tasks such as data analysis, real-time decision-making, and secure communication directly at the network's edge. For example, in a factory, the apparatus may be located in an edge gateway that monitors and processes data from various sensors on the production floor in real-time, facilitating immediate responses to operational changes and enhancing overall system efficiency.

In some examples, the apparatus 10 may deregister the selected node from the trust cluster. Deregistering or offboarding may involve removing the node's authentication and trust status, thereby revoking its privileges to communicate and interact with other nodes within the cluster. This action ensures that untrusted or compromised nodes no longer have access to sensitive resources or data within the network. Deregistration may be triggered by several factors such as security breaches, performance degradation, or policy violations. For instance, if a node exhibits suspicious behavior or fails to comply with security protocols, the apparatus may initiate the deregistration process to isolate and exclude the node from the trust cluster, thereby maintaining the integrity and security of the overall system. The deregistration or offboarding process ensures that nodes can be removed or migrated based on changing conditions, such as resource constraints or security threats.

In some examples, the selected node is deregistered when the selected node is failing, the selected node is re-attested and fails re-attestation, or the selected node is denoted as untrusted by another attestation service. Failing may refer to the node experiencing operational issues such as hardware malfunctions, software errors, or performance inefficiencies that impede its functionality. Re-attested may mean that the node undergoes a subsequent attestation process to verify its continued compliance and security status within the trust cluster. If the node fails this re-attestation, indicating potential compromises or deviations from security policies, it may be subject to deregistration. Additionally, if another attestation service within the network identifies the node as untrusted, perhaps due to conflicting attestation reports or detected anomalies, the apparatus may deregister the node to prevent security breaches. For example, if an edge device begins to exhibit erratic behavior or cannot pass a second round of security checks, it will be deregistered to protect the trust cluster from potential threats.

In some examples, the selected node is listed in a blockchain of untrusted nodes and the selected node is deregistered from the trust cluster. A blockchain of untrusted nodes is a distributed and immutable ledger that records the identities and statuses of nodes that have been identified as untrustworthy or compromised. Utilizing blockchain technology may ensure that the information regarding untrusted nodes is securely stored, transparent, and resistant to tampering or unauthorized alterations. Once a node is flagged and recorded in this blockchain, the apparatus may automatically deregister the node from the trust cluster to prevent any future interactions or access to sensitive resources. For instance, if a node is detected to have been compromised by malware or a virus, its details may be added to the blockchain of untrusted nodes, ensuring that all trust authorities within the network recognize and exclude it from the trust cluster operations.

In some examples, the selected node is within a second network comprising a second local attestation service, wherein attesting the selected node comprises communicating with the second local attestation service, and registering the selected node with the trust cluster further registers the second network within the trust cluster. A second local attestation service may refer to an additional trust authority operating within another distinct network that independently verifies and attests to the integrity and security of nodes within its domain. The second network could represent a different geographical location, organizational unit, or specialized operational segment that requires its own attestation mechanisms. When the apparatus attests the selected node through the second local attestation service in this peer-to-peer manner, it may not only validate the node's trustworthiness but may also extend the trust cluster's scope by integrating the second network into the overarching trust cluster. For example, a multinational corporation may have separate attestation services for its regional offices; once a device from a regional office is successfully attested, the second network (the regional office's network) may automatically be incorporated into the main trust cluster.

FIG. 1 further shows a system 100 comprising processor circuitry 30, and a non-transitory, machine-readable medium 20 storing program code 20a. The processor circuitry 30 may be coupled to the machine-readable medium 20 via a memory channel. The program code 20a, when executed by the processor circuitry 30, enables the system 100 to function as a local attestation service of a network within a trust cluster. The system may be configured to communicate with a selected node outside the trust cluster, attest the selected node, and, when attestation of the selected node is successful, register the selected node within the trust cluster.

The computer system 100 may be at least one of a client computer system, a server computer system, a rack server, a desktop computer system, a mobile computer system, a security gateway, and a router. The system 100 may also be a smartphone, tablet, wearable, or mobile computer.

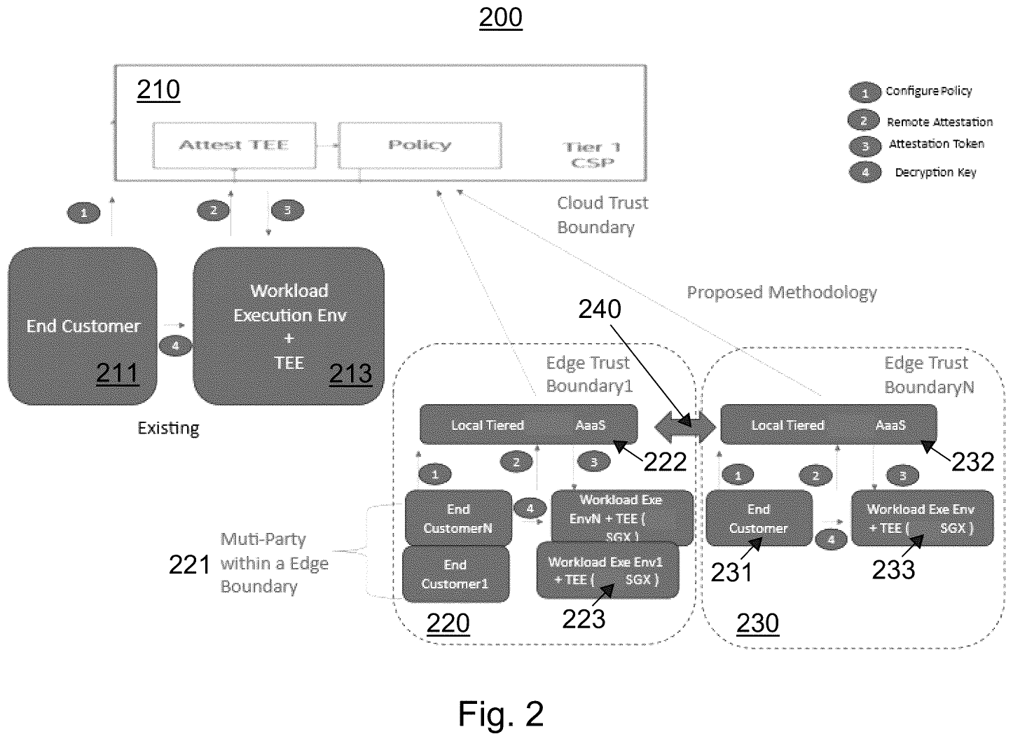

More details and optional aspects of the local attestation service of FIG. 1 may be described in connection with examples described below (e.g. FIGS. 2 to 5).

FIG. 2 shows an example system 200 with tiered Attestation as a Service (TAaaS). The figure a shows a tiered system 200 with both a centralized AaaS and a local attestation services in which there is an edge-to-edge (c2c) system 220, 230, with trust between their nodes 222, 232 at the edge. In other words, the nodes 220, 230 know each other and trust a centralized cloud component 210. The right portion of FIG. 2 highlights the local TAaaS wherein one to many participating end customers and their associated workloads being orchestrated in respective local edge environment or on-premises. Here nodes may be attested along with any AI Models/Data being retained within the closed loop envelope instead of going to an untrusted public cloud service. Additionally the tiered mechanism may allow peer-to-peer AaaS capabilities for multi-party confidential computing within an edge infrastructure (shown in double arrow 240).

The disclosed local trust authority is a platform that scales to meet the demands of modern enterprise computing environments. The primary function of this local trust authority is to attest to the integrity of TEEs by validating that workloads running within these environments have not been compromised. This may be accomplished through TEE-instance setup, a verification process, attestation policy matching, attestation token generation, and token verification.

In FIG. 2, users 211, 221, 231 of each network 220, 220 may configure a confidential computing environment, such as a TEE 213, 223, 233, which may include workloads at the application level or virtual machine (VM) level. The TEE generates cryptographically signed evidence, which includes identity and integrity measurements of the environment. This evidence is transmitted to the local TAaaS 222, 232 for attestation. The local TAaaS 222, 232 matches the cryptographically signed evidence against pre-defined security policies configured by the user. These policies define the expected identity and integrity metrics of the computing environment. Then, if the environment passes the attestation checks, the TAaaS 222, 232 issues an attestation token. This token is cryptographically signed and serves as proof that the environment is trusted and secure. Any relying party can verify the attestation token's signature and ensure that the environment has met the necessary security policies. Once verified, workloads and data can be safely decrypted and executed within the TEE.

Centralized AaaS systems may not support decentralized operations necessary for diverse, multi-cloud environments. When a healthcare provider collaborates with a drug developer, both of which operating within a separate edge cloud, centralized attestation might hinder seamless and secure integration, necessitating a more flexible, decentralized approach.

The proposed solution introduces a decentralized model wherein multiple trust authorities operate within different edge networks. Each company operating an edge node might establish its own sub trust authority, enabling independent verification and management of compute resources. For instance, a primary trust authority may oversee the overall trust framework, while individual sub trust authorities handle attestation and monitoring within their respective edge networks. This hierarchical or tiered trust capability allows for real-time collaboration across multiple edge environments, enhancing scalability and resilience.

To enhance flexibility, the disclosed TAaaS architecture may support hierarchical trust capabilities. This enables the system to support security beyond central CPUs to include XPUs, GPUs, or other AI accelerators. By extending the trust boundary from CPUs to various accelerators, the system can secure a wider range of computational resources, accommodating the evolving needs of AI-centric and high-performance computing applications. For example, in a data center, GPUs used for AI tasks might be independently attested and trusted, ensuring that sensitive AI models are executed securely. Remote attestation may be done across private and on-premises networks compared to through a public cloud. Additive Homomorphic encryption based attestation may be done when data or AI Models transition from client to the network to the cloud. Attestation may be done multi-party confidential compute environment.

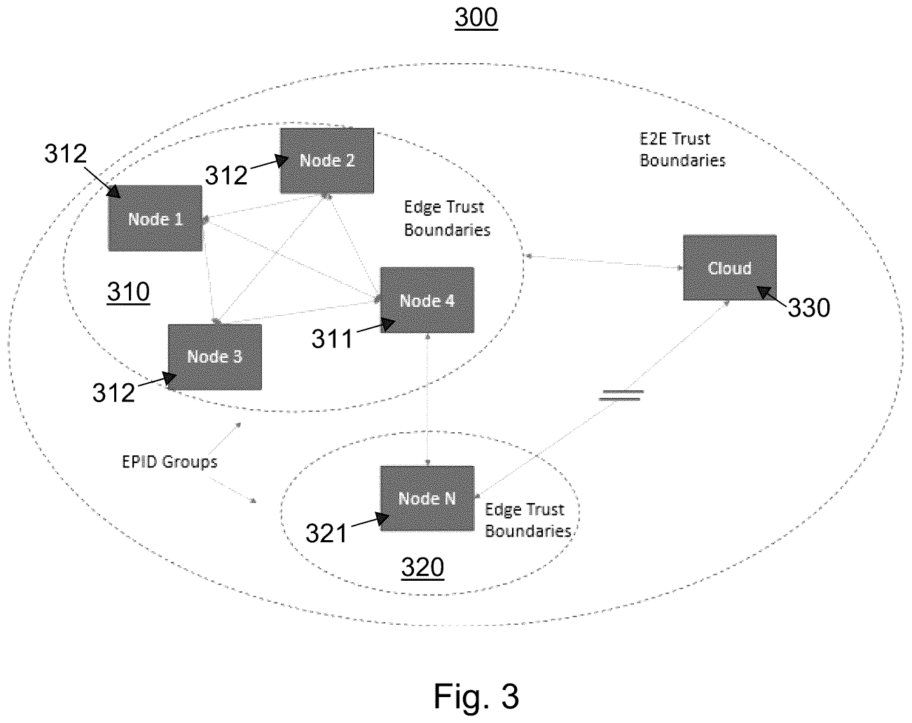

More details and aspects of the concept for the local attestation service may be described in connection with examples discussed above (e.g. FIG. 1) or below (e.g. FIGS. 3 to 5).

FIG. 3 shows an example system 300 with attestation boundaries and addition of a new node. In this figure, a new node or selected node 321 is added, which may be, for example, offline from the cloud component 330 or not trusted. However, the new node 321 may be visible to one node 311 of the peers 312 in the edge trusted cluster 310. The trust cluster 310 may be, for example, an EPID Group. The new node 321 may be one of a plurality of nodes in its own trust cluster 320. The discovery may happen with a regular gossip protocol. After that a secure handshake may be performed to understand security capabilities of the selected node 321. Once secure channel is established, the new node 321 may be in evaluation phase. This may mean having a mark or tag on all the produced data. After the evaluation time, when node 321 becomes trusted for the edge trusted boundary, it can provide security services, communicate freely with the other nodes, and may be open to talk to new nodes for their inclusion.

The architecture supports hierarchical and distributed trust management, allowing multiple trust authorities to operate collaboratively while maintaining consistent security policies. Sub trust authorities might continuously engage in gossip protocols to monitor node health, support levels, and capacity, enabling the network to dynamically adjust trust relationships and resource allocations. For example, in a scenario where a primary trust authority detects resource exhaustion in one edge network, sub trust authorities might collaborate to redistribute workloads to other edge nodes with available capacity, maintaining overall system performance and security.

The proposed architecture may also extend trust boundaries from CPUs to XPUs, enabling secure operations on a broader range of computational accelerators such as GPUs and AI accelerators. This extension may allow for securing more diverse workloads, including AI-driven applications that leverage specialized hardware. For instance, an AI accelerator within an edge node might undergo separate attestation processes to ensure that its operations are secure and trusted, thereby enhancing the overall security framework of the trust cluster.

The implementation of local trust authorities might leverage various technologies, including blockchain for distributed revocation management and gossip protocols for decentralized trust monitoring. By maintaining security gradients through hierarchical trust authorities, the system ensures consistent security policies while allowing for flexibility and scalability. Additionally, by supporting AI accelerators and extending trust boundaries beyond traditional CPUs, AaaS adapts to evolving computational demands and enhances security across diverse processing environments.

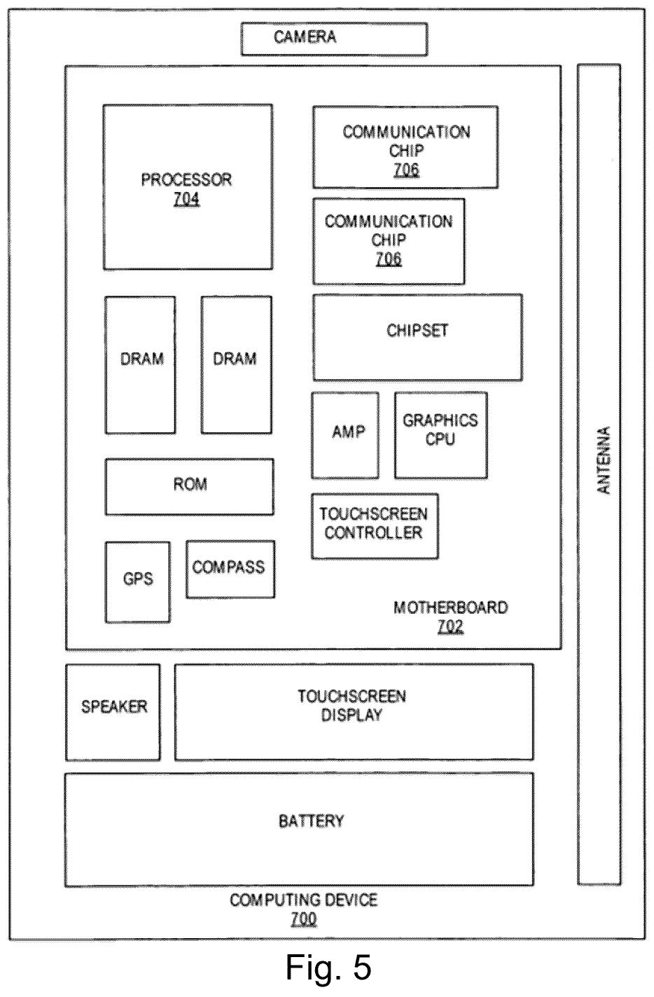

More details and aspects of the concept for the local attestation service may be described in connection with examples discussed above (e.g. FIGS. 1 to 2) or below (e.g. FIGS. 4 to 5).

FIG. 4 illustrates a flowchart of an example of a method 400 for a local attestation service. The method 400 may, for instance, be performed by an apparatus as described herein, such as apparatus 10. The method 400 may comprise communicating 410 with a selected node outside the trust cluster; attesting 420 the selected node; and when attestation of the selected node is successful, registering 430 the selected node within the trust cluster. In some embodiments, the method may include establishing 411 a secure channel between the apparatus and the selected node. In some embodiments, prior to successful attestation, the selected node may be in an evaluation phase and data produced by the selected node during the evaluation phase may be marked 413.

In some embodiments, after registering the selected node within the trust cluster, the method 400 may comprise periodically reevaluating 440 the selected node for power and/or cost efficiencies and migrate the selected node to another network within the trust cluster when a threshold is met. In some embodiments, the method 400 may further comprise deregistering 450 the selected node from the trust cluster.

More details and aspects of the concept for the local attestation service may be described in connection with examples discussed above (e.g. FIGS. 1 to 3) or below (e.g. FIG. 5).

FIG. 5 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g. DRAM), non-volatile memory (such as, ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as, hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the invention, the integrated circuit die of the processor includes one or more devices that are assembled in an ePLB or cWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

More details and aspects of the concept for the local attestation service are mentioned in connection with the proposed concept or one or more examples described above (e.g. FIGS. 1 to 5) or below. The concept the local attestation service may comprise one or more additional optional features corresponding to one or more aspects of the proposed concept or one or more examples described above or below.

The aspects and features described in relation to a particular one of the previous examples may also be combined with one or more of the further examples to replace an identical or similar feature of that further example or to additionally introduce the features into the further example.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g. example 1) relates to an apparatus for a local attestation service of a network within a trust cluster, the apparatus comprising interface circuitry, memory circuitry, machine-readable instructions, and processor circuitry to execute the machine-readable instructions to: communicate with a selected node outside the trust cluster; attest the selected node; and when attestation of the selected node is successful, register the selected node within the trust cluster.

Another example (e.g. example 2) relates to a previously described example (e.g. example 1), wherein the selected node is discovered when it is visible to a node within the trust cluster.

Another example (e.g. example 3) relates to a previously described example (e.g. any one of examples 1 or 2), further comprising the machine-readable instructions to establish a secure channel between the apparatus and the selected node.

Another example (e.g. example 4) relates to a previously described example (e.g. any one of examples 1 to 3), wherein the selected node comprises a confidential computing environment and attesting the selected node comprises attesting confidential computing environment.

Another example (e.g. example 5) relates to a previously described example (e.g. any one of examples 1 to 4), wherein after successful attestation, the selected node is registered to do at least one of the following: communicate with other nodes in the trust cluster, provide security services, and discover further selected nodes outside the trust cluster.

Another example (e.g. example 6) relates to a previously described example (e.g. any one of examples 1 to 5), wherein, prior to successful attestation, the selected node is in an evaluation phase.

Another example (e.g. example 7) relates to a previously described example (e.g. example 6), wherein data produced by the selected node during the evaluation phase is marked.

Another example (e.g. example 8) relates to a previously described example (e.g. any one of examples 6 or 7), wherein the trust cluster comprises a plurality of networks and wherein during the evaluation phase the selected node is evaluated for power and/or cost efficiencies and, after successful attestation, registered with one of the plurality of networks when a threshold is met.

Another example (e.g. example 9) relates to a previously described example (e.g. any one of examples 1 to 8), further comprising machine-readable instructions to, after registering the selected node within the trust cluster, periodically reevaluate the selected node for power and/or cost efficiencies and migrate the selected node to another network within the trust cluster when a threshold is met.

Another example (e.g. example 10) relates to a previously described example (e.g. any one of examples 1 to 9), wherein the apparatus is an edge apparatus of the network.

Another example (e.g. example 11) relates to a previously described example (e.g. any one of examples 1 to 10), further comprising machine-readable instructions to deregister the selected node from the trust cluster.

Another example (e.g. example 12) relates to a previously described example (e.g. example 11), wherein the selected node is deregistered when at least one of the following: the selected node is failing; the selected node is re-attested and fails re-attestation; and the selected node is denoted as untrusted by another attestation service.

Another example (e.g. example 13) relates to a previously described example (e.g. any one of examples 11 or 12), wherein the selected node is listed in a blockchain of untrusted nodes and the selected node is deregistered from the trust cluster.

Another example (e.g. example 14) relates to a previously described example (e.g. any one of examples 1 to 13), wherein the selected node is within a second network comprising a second local attestation service, wherein attesting the selected node comprise communicating with the second local attestation service, and registering the selected node with the trust cluster further registers the second network within the trust cluster.

An example (e.g. example 15) relates to method for a local attestation service of a network within a trust cluster, the method comprising: communicating with a selected node outside the trust cluster; attesting the selected node; and when attestation of the selected node is successful, registering the selected node within the trust cluster.

Another example (e.g. example 16) relates to a previously described example (e.g. example 15), wherein the selected node is discovered when it is visible to a node within the trust cluster.

Another example (e.g. example 17) relates to a previously described example (e.g. any one of examples 15 or 16), further comprising establishing a secure channel between the apparatus and the selected node.

Another example (e.g. example 18) relates to a previously described example (e.g. any one of examples 15 to 17), wherein the selected node comprises a confidential computing environment and attesting the selected node comprises attesting confidential computing environment.

Another example (e.g. example 19) relates to a previously described example (e.g. any one of examples 1 to 18), wherein after successful attestation, the selected node is registered to do at least one of the following: communicate with other nodes in the trust cluster, provide security services, and discover further selected nodes outside the trust cluster.

Another example (e.g. example 20) relates to a previously described example (e.g. any one of examples 15 to 19), wherein, prior to successful attestation, the selected node is in an evaluation phase.

Another example (e.g. example 21) relates to a previously described example (e.g. example 20), wherein data produced by the selected node during the evaluation phase is marked.

Another example (e.g. example 22) relates to a previously described example (e.g. any one of examples 20 or 21), wherein the trust cluster comprises a plurality of networks and wherein during the evaluation phase the selected node is evaluated for power and/or cost efficiencies and, after successful attestation, registered with one of the plurality of networks when a threshold is met.

Another example (e.g. example 23) relates to a previously described example (e.g. any one of examples 15 to 22), further comprising, after registering the selected node within the trust cluster, periodically reevaluating the selected node for power and/or cost efficiencies and migrate the selected node to another network within the trust cluster when a threshold is met.

Another example (e.g. example 24) relates to a previously described example (e.g. any one of examples 15 to 23), wherein the apparatus is an edge apparatus of the network.

Another example (e.g. example 25) relates to a previously described example (e.g. any one of examples 15 to 24), further comprising deregistering the selected node from the trust cluster.

Another example (e.g. example 26) relates to a previously described example (e.g. example 25), wherein the selected node is deregistered when at least one of the following: the selected node is failing; the selected node is re-attested and fails re-attestation; and the selected node is denoted as untrusted by another attestation service.

Another example (e.g. example 27) relates to a previously described example (e.g. any one of examples 25 or 26), wherein the selected node is listed in a blockchain of untrusted nodes and the selected node is deregistered from the trust cluster.

Another example (e.g. example 28) relates to a previously described example (e.g. any one of examples 15 to 27), wherein the selected node is within a second network comprising a second local attestation service, wherein attesting the selected node comprise communicating with the second local attestation service, and registering the selected node with the trust cluster further registers the second network within the trust cluster.

An example (e.g. example 29) relates to a non-transitory, computer-readable medium comprising a program code that, when the program code is executed on a processor, a computer, or a programmable hardware component, causes the processor, computer, or programmable hardware component to perform any one of the methods a previously described example (e.g. any one of examples 15 to 28).)

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g. machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g. via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. An apparatus for a local attestation service of a network within a trust cluster, the apparatus comprising interface circuitry, memory circuitry, machine-readable instructions, and processor circuitry to execute the machine-readable instructions to:
communicate with a selected node outside the trust cluster;
attest the selected node; and
when attestation of the selected node is successful, register the selected node within the trust cluster.

2. The apparatus of claim 1, wherein the selected node is discovered when it is visible to a node within the trust cluster.

3. The apparatus of claim 1, further comprising the machine-readable instructions to establish a secure channel between the apparatus and the selected node.

4. The apparatus of claim 1, wherein the selected node comprises a confidential computing environment and attesting the selected node comprises attesting confidential computing environment.

5. The apparatus of claim 1, wherein after successful attestation, the selected node is registered to do at least one of the following:
communicate with other nodes in the trust cluster,
provide security services, and
discover further selected nodes outside the trust cluster.

6. The apparatus of claim 1, wherein, prior to successful attestation, the selected node is in an evaluation phase.

7. The apparatus of claim 6, wherein data produced by the selected node during the evaluation phase is marked.

8. The apparatus of claim 6, wherein the trust cluster comprises a plurality of networks and wherein during the evaluation phase the selected node is evaluated for power and/or cost efficiencies and, after successful attestation, registered with one of the plurality of networks when a threshold is met.

9. The apparatus of claim 1, further comprising machine-readable instructions to, after registering the selected node within the trust cluster, periodically reevaluate the selected node for power and/or cost efficiencies and migrate the selected node to another network within the trust cluster when a threshold is met.

10. The apparatus of claim 1, wherein the apparatus is an edge apparatus of the network.

11. The apparatus of claim 1, further comprising machine-readable instructions to deregister the selected node from the trust cluster.

12. The apparatus of claim 11, wherein the selected node is deregistered when at least one of the following:
the selected node is failing;
the selected node is re-attested and fails re-attestation; and
the selected node is denoted as untrusted by another attestation service.

13. The apparatus of claim 11, wherein the selected node is listed in a blockchain of untrusted nodes and the selected node is deregistered from the trust cluster.

14. The apparatus of claim 1, wherein the selected node is within a second network comprising a second local attestation service, wherein attesting the selected node comprise communicating with the second local attestation service, and registering the selected node with the trust cluster further registers the second network within the trust cluster.

15. A method for a local attestation service of a network within a trust cluster, the method comprising:
communicating with a selected node outside the trust cluster;
attesting the selected node; and
when attestation of the selected node is successful, registering the selected node within the trust cluster.

16. A non-transitory, computer-readable medium comprising a program code that, when the program code is executed on a processor, a computer, or a programmable hardware component, causes the processor, computer, or programmable hardware component to perform the method of claim 15.
